(19) United States
(12) Patent Application Publication
(10) Pub. No.: US 2004/0150620 A1
(43) Pub. Date: Aug. 5, 2004

(54) Digital input device

(75) Inventor: Chi Wang Tsen, Taipei (TW)

Correspondence Address: BROWDY AND NEIMARK, P.L.L.C., 624 NINTH STREET, NW, SUITE 300, WASHINGTON, DC, 20001-5303, US

(73) Assignee: Loyalty Founder Enterprise Co., Ltd., Tao Yuan City (TW)

(21) Appl. No.: 10/357,478

(22) Filed: Feb. 4, 2003

(51) Int. Cl. G09G 5/08

(52) U.S. Cl. 345/163

(57) ABSTRACT

A digital input device is constructed with a housing carrying a circuit board having encoders for producing a cursor positioning control signal. The housing has an upright stub tube in a bottom wall thereof, a positioning member disposed at an outer end of the upright stub tube, a ball receptacle disposed at an inner end of the upright stub tube, and a link coupled to the ball receptacle and the positioning member for enabling the housing to be moved relative to the positioning member and adapted to drive the encoders to output a cursor positioning control signal for controlling positioning of a cursor on a display screen when the housing moved relative to the positioning member.

### BACKGROUND OF THE INVENTION

1. Field of the Invention

The present invention relates to an input device for use in a computer to control the positioning of a cursor on a display screen and, more particularly to a digital input device that can be used as a substitute for a computer mouse or trackball.

2. Description of the Related Art

Following fast development of information technology, a computer has become an important electric appliance in daily life. Regular computer software provides window communication interface for easy communication between people and machines. By means of operating a mouse or trackball in a keyboard, a user controls the positioning of a cursor on the display screen of a computer system. When a computer mouse or trackball is used, the operator must move the mouse or the trackball with the fingers. The moving parts of a computer mouse of trackball tend to be covered with dirt after a long use, resulting in poor operating sensitivity. Therefore, a computer mouse or trackball must be regularly cleaned.

Another conventional means of controlling cursor position is a computer mouse using an optical induction means. However, the optical induction means is sensitive to the color of the tabletop or mouse pad. Therefore, an optical computer mouse must be moved across a flat surface of light color.

### SUMMARY OF THE INVENTION

The present invention is thus directed towards a digital input device that eliminates the above-mentioned drawbacks. It is the main object of the present invention to provide a digital input device, which can be used as a substitute for a computer mouse or trackball. It is another object of the present invention to provide a digital input device, which is free from limitations on place of operation. To achieve these and other objects of the present invention, the digital input device comprises a housing adapted to. carry a circuit. board having an encoder means for producing a control signal to control positioning of a cursor on a display screen. The housing comprises an upright stub tube in a bottom wall thereof, the upright stub tube having a top opening inside the housing and a bottom opening outside the housing. A positioning member is disposed outside the housing at an outer side of the bottom opening of the upright stub tube. A ball receptacle is fixedly mounted inside the housing at an outer side of the top opening of the upright stub tube, and the ball receptacle defines a ball hole. A transmission mechanism is adapted to drive encoder means in a circuit board installed in the housing to output a control signal for controlling positioning of a cursor on a display screen. A link is inserted through the ball receptacle and coupled between the positioning member and the transmission mechanism for enabling the housing to be moved relative to the positioning member and adapted to force the transmission mechanism to drive encoder means of a circuit board installed in the housing. The link has a first ball fixedly located on a bottom end thereof and fastened pivotally with the positioning member, a second ball fixedly located on a middle part thereof and received in the ball hole of the ball receptacle, and a top free end coupled to the transmission mechanism.

### BRIEF DESCRIPTION OF THE DRAWINGS

The various objects and advantages of the present invention will be more readily understood from the following detailed description when read in conjunction with the appended drawings, in which:

FIG. 1 is an exploded view of a digital input device according to the present invention;

FIG. 2 is a perspective assembly view of the digital input device according to the present invention;

FIG. 3 is a side view, partially in cross section, of the digital input device according to the present invention;

FIG. 4 is a sectional view showing one operation action of the digital input device according to the present invention;

FIG. 5 is a sectional view showing another operation action of the digital input device according to the present invention; and

FIG. 6 shows the digital input device used in a notebook computer according to the present invention.

### DETAILED DESCRIPTION OF THE PREFERRED EMBODIMENT

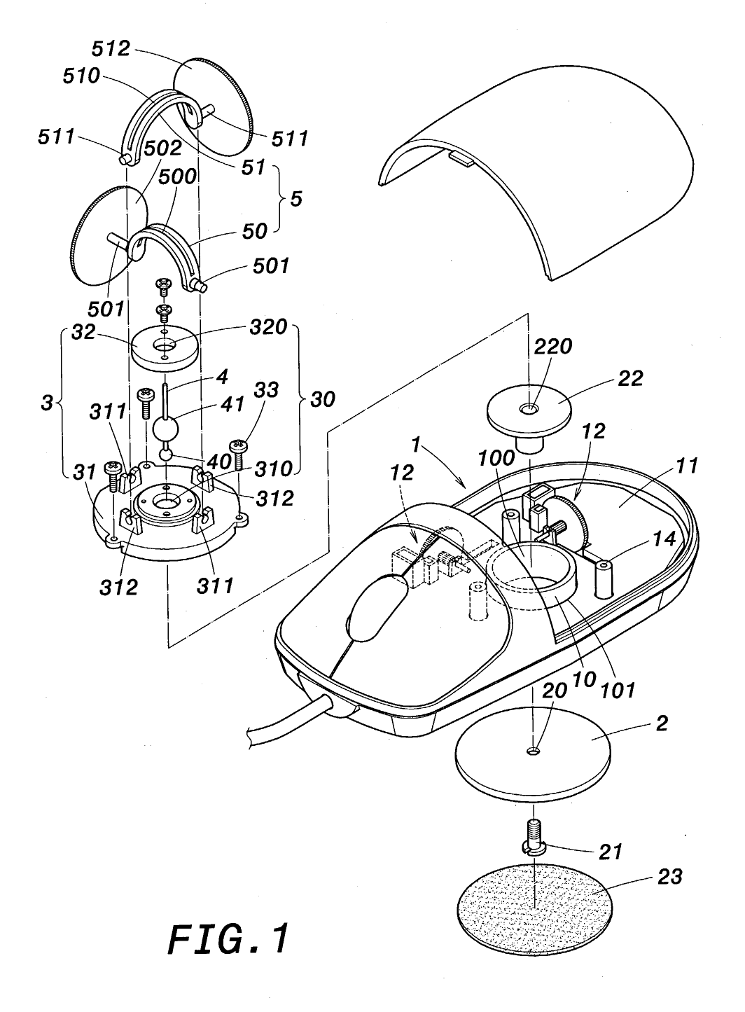

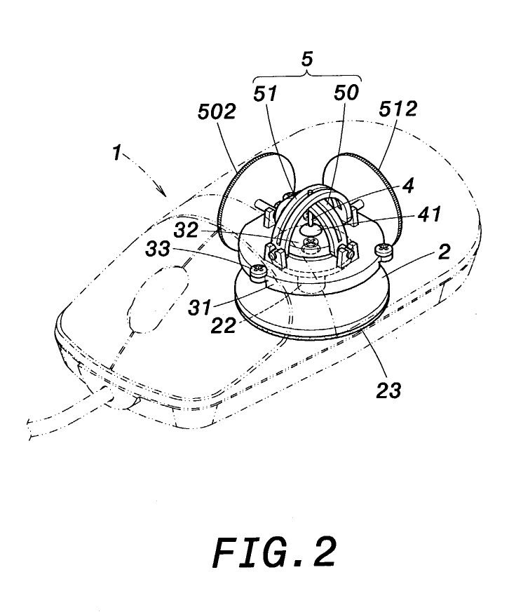

Referring to FIGS. 1, 2, and 3, a digital input device in accordance with the present invention is shown comprised of a housing 1, a positioning member 2, a ball receptacle 3, a link 4, and a transmission mechanism 5.

The housing 1 is a computer mouse carrying a circuit board 11 and encoders (X-axis and Y-axis encoders) 12. The body 1 has an upright stub tube 10 disposed adjacent to the encoders 12, a plurality of upright posts 14 equiangularly spaced around the upright stub tube 10, and a bottom recess 13 in the bottom surface around one end of the upright stub tube 10. The upright stub tube 10 has a top opening 100 disposed inside the body 1, and a bottom opening 101 disposed outside the housing 1.

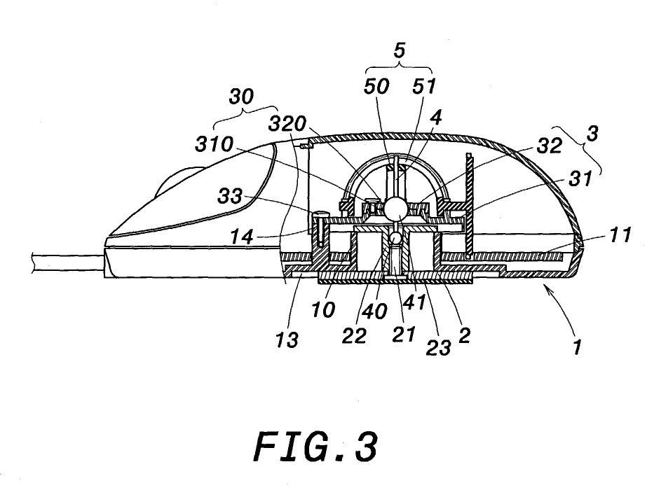

The positioning member 2 is a circular plate member suspended outside the bottom opening 101 of the upright stub tube 10 within the bottom recess 13 of the housing 1 (see FIG. 3), and has a center mounting hole 20. A screw bolt 21 is threaded into the mounting hole 20 of the positioning member 2 and the center mounting through hole 220 of a connector 22 inside the housing 1 to secure the positioning member 2 to the upright stub tube 10, enabling the positioning member 2 to be rotated on the bottom end (the end defining the bottom opening 101) of the upright stub tube 10. Alternatively, the positioning member 2 can be fastened pivotally with the bottom end of the upright stub tube 10 by a rivet joint or the like. Further, the center mounting through hole 220 of the connector 22 has a lower end-threaded for engagement with the screw bolt 21.

The ball receptacle 3 is disposed outside the top opening 100 of the upright stub tube 10 within the housing 1, defining a ball hole 30. The ball receptacle 3 comprises a first receptacle member 31 and a second-receptacle member 32. The first receptacle member 31 is fixedly fastened to the upright posts 14 above the upright stub tube 10 by screws 33, and has a tapered center through hole 310. The diameter of the tapered center through hole 310 increases gradually from the bottom side of the first receptacle member 31 toward the top side thereof. The second receptacle member 32 is fastened to the top side of the first receptacle member 31, and has a tapered center through hole 320 disposed in communication with the tapered center through hole 310 of the first receptacle member 31. The diameter of the tapered center through hole 320 increases gradually from the top side of the second receptacle member 32 toward the bottom side thereof. When the second receptacle member 32 fixedly fastened to the first receptacle member 31, the tapered center through holes 310 and 320 form the aforesaid ball hole 30.

The link 4 is a rod member inserted through the ball hole 30 of the ball receptacle 3, and has a first ball 40 fixedly provided at the bottom end and inserted into the center mounting through hole 220 of the connector 22 and disposed in contact with the peripheral wall of the center mounting through hole 220. A second ball 41 is fixedly provided on the middle and received in the ball hole. 30 of the ball receptacle 3. The top end (the end remote from the first ball 40) of the link 4 is a free end.

The transmission mechanism 5 is coupled to the free end of the link 4, and is adapted to transmit driving force from the link 4 to the encoders 12 for controlling the positioning of the cursor on the display screen (not shown). The transmission mechanism 5 comprises a first arched transmission device 50 and a second arched transmission device 51 arranged at right angles across from each other. The first arched transmission device 50 comprises two pivot rods 501 respectively fastened pivotally with first pivot bearings 311 at the first receptacle member 31, a longitudinally slotted arched sliding track 500 connected between the pivot rods 501, and a transmission wheel 502 located on one pivot rod 501. The second arched transmission device 51 comprises two pivot rods 511 respectively fastened pivotally with second pivot bearings 312 at the first receptacle member 31, a longitudinally slotted arched sliding track 510 connected between the pivot rods 511, and a transmission wheel 512 located on one pivot rod 511. The free end of the link 4 is inserted through the longitudinally slotted arched sliding tracks 500 and 510 of the first and second arched transmission devices 50 and 51. The transmission wheels 502 and 512 of the first and second arched transmission devices 50 and 51 are respectively meshed with the encoders 12. According to this embodiment the first pivot bearings 311 and the second pivot bearings 312 are fixedly located on the first receptacle member 31. Alternatively, the first pivot bearings 311 and the second pivot bearings 312 can be formed integral with the housing 1.

Further, a skid-free pad (or adhesion pad) 23 is fixedly fastened to the positioning member 2 to increase the friction force between the positioning member 2 and external means touching the positioning member 2.

When the user moves the housing 1 after the digital input device has been put on top of a table or a mouse pad, the skid-free pad 23 keeps the positioning member 2 immobile on the top of the table or the mouse pad, and the free end of the link 4 is moved with the housing 1 to drive the first and second arched transmission devices 50 and 51, thereby causing the encoders 12 to output a control signal indicative of the amount and direction of the movement of the housing 1 relative to the positioning member 2.

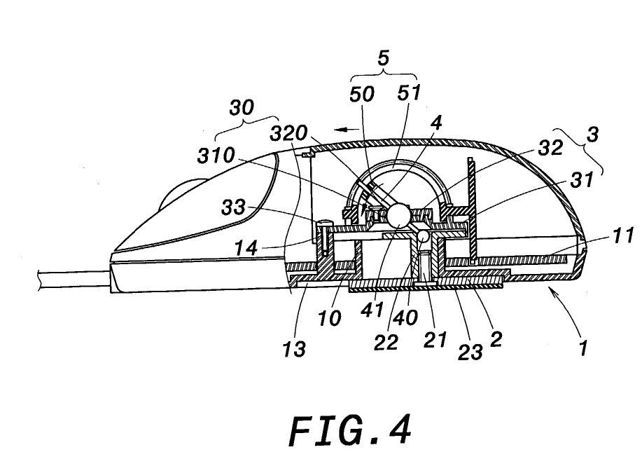

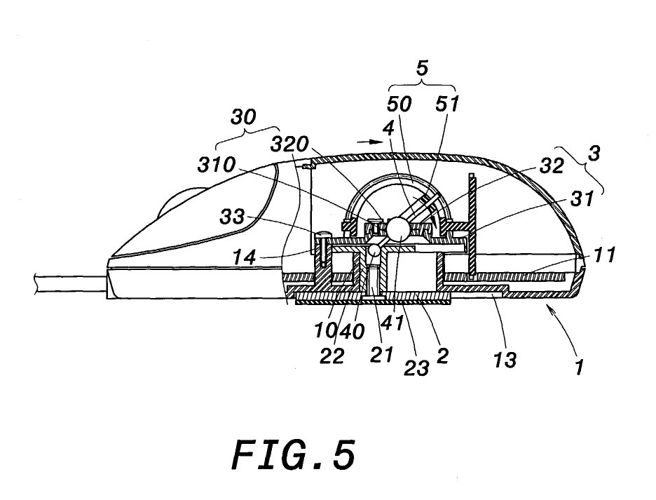

Referring to FIGS. 4 and 5, when the housing 1 moved forwards, the free end of the link 4 is forced to move the first arched transmission device 50, thereby causing the transmission wheel 502 of the first arched transmission device 50 to rotate the (grid wheel of the) corresponding encoder 12, and therefore the corresponding encoder 12 is driven to output a control signal to move the cursor forwards on the display screen (see FIG. 4). When the housing 1 moved backwards, the free end of the link 4 is forced to move the second arched transmission device 51, thereby causing. the transmission wheel 512 of the second arched transmission device 51 to rotate the (grid wheel of the) corresponding encoder 12, and therefore the corresponding encoder 12 is driven to output a control signal to move the cursor backwards. on the display screen (see FIG. 5). When the housing 1 moves to the left or right, the free end of the link 4 is forced to move the first arched transmission device 50 or second arched transmission device 51 thereby causing the corresponding encoder 12 to output a control signal to move the cursor leftwards or rightwards on the display screen. When the housing 1 moves toward the upper left, upper right, lower left, or lower right side, or rotated relative to the positioning member 2, the first arched transmission device 50 and the second arched transmission device 51 are relatively moved to drive the encoders 12, thereby causing the encoders 12 to output a control signal to move the cursor on the display screen in the same direction.

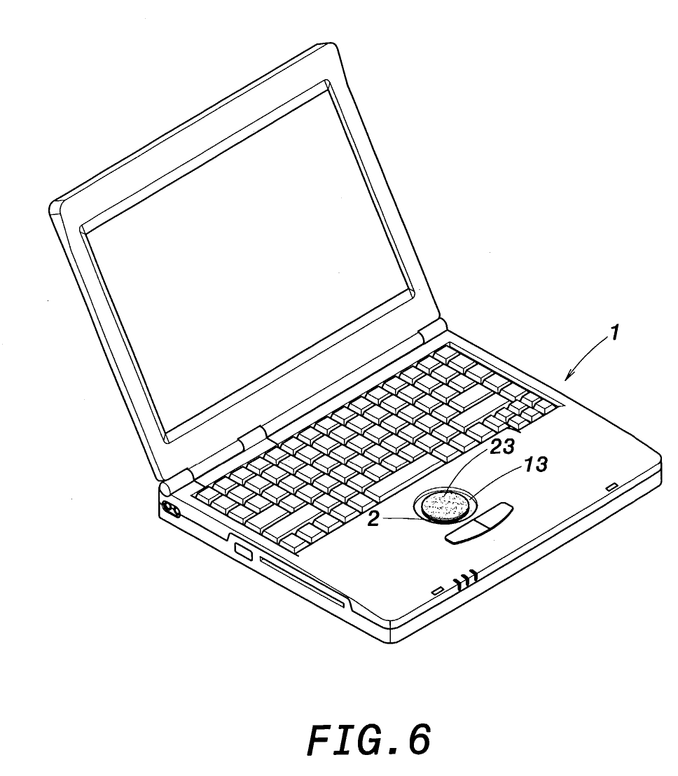

FIG. 6 shows the digital input device used in a notebook computer. In this case, the housing 1 forms a part of the keyboard cover shell, and the digital input device is disposed in an inverted position, keeping the skid-free pad 23 and the positioning member 2 suspended in the bottom recess 13 of the housing 1 and exposed to the outside for operation by hand. Further, the digital input device can also be used in a computer keyboard as a substitute for a trackball.

As indicated above the digital input device of the present. invention has the following advantages:

1. Because the relative movement between the housing 1 and the positioning member 2 achieves the control of the positioning of the cursor on the display screen, the link 4 is kept away from dirt carried on the table top or mouse pad or the user's fingers.

2. Because the positioning member 2 is kept immobile when the digital input device used as a computer mouse, the digital input. device can be positioned on a sloped surface, the thigh of the leg, or any of a variety of places not suitable for the use of a conventional optical mouse or trackball type mouse.

3. Because the positioning member 2 is maintained immobile when operating the digital input device, the digital input device can be used in a narrow space without mouse pad.

A prototype of digital input device has been constructed with the features of FIGS. 1-6. The digital input device functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A digital input device comprising:
a housing adapted to carry a circuit board having encoder means for producing a control signal to control positioning of a cursor on a display screen, said housing comprising an upright stub tube in a bottom wall thereof, said upright stub tube having a top opening inside said housing and a bottom opening outside said housing;
a positioning member disposed outside said housing at an outer side of the bottom opening of said upright stub tube;
a ball receptacle fixedly mounted inside said housing at an outer side of the top opening of said upright stub tube, said ball receptacle defining a ball hole; and
a link coupled to said ball receptacle and said positioning member for enabling said housing to be moved relative to said positioning member and adapted to drive encoder means of a circuit board installed in said housing to output a control signal for controlling positioning of a cursor on a display screen, said link having a first ball fixedly located on a bottom end thereof and fastened pivotally with said positioning member, and a second ball fixedly located on a middle part thereof and received in the ball hole of said ball receptacle.

2. The digital input device as claimed in claim 1, wherein said housing has a bottom recess adapted to receive said positioning member.

3. The digital input device as claimed in claim 2, wherein said positioning member has a part protruding over said bottom recess.

4. The digital input device as claimed in claim 1, further comprising a connector fastened pivotally with said upright stub tube inside said housing and connected to said positioning member to secure said positioning member to said housing for enabling said housing to be moved relative to said positioning member, said fastening means having a through hole, wherein said receives the first ball of said link.

5. The digital input device as claimed in claim 4, wherein said positioning member has a mounting through hole fastened to the through hole of said connector with a screw bolt.

6. The digital input device as claimed in claim 4, wherein said connector is formed integrally with a part of said positioning member.

7. The digital input device as claimed in claim 1, wherein said positioning member has an outside wall fixedly mounted with a skid-free pad.

8. The digital input device as claimed in claim 1, wherein said positioning member has an outside wall fixedly mounted with an adhesion pad.

9. The digital input device as claimed in claim 1, wherein the ball hole of said ball receptacle comprises a first tapered through hole and a second tapered through hole vertically aligned with said first tapered through hole in a line, said first tapered through hole having a diameter gradually increasing from a bottom side toward a top side, said second tapered through hole having a diameter gradually increasing from a top side toward a bottom side.

10. The digital input device as claimed in claim 9, wherein said ball receptacle comprises a first receptacle member defining said first tapered through hole, and a second receptacle member mounted on a top side of said first receptacle member and defining said second tapered through hole.

11. A digital input device comprising:
a housing adapted to carry a circuit board having an encoder means for producing a control signal to control positioning of a cursor on a display screen said housing comprising an upright stub tube in a bottom wall thereof, said upright stub tube having a top opening inside said housing and a bottom opening outside said housing;
a positioning member disposed outside said housing at an outer side of the bottom opening of said upright stub tube;
a ball receptacle fixedly mounted inside said housing at an outer side of the top opening of said upright stub tube, said ball receptacle defining a ball hole;
a transmission mechanism adapted to drive the encoder means in a circuit board installed in said housing to output a control signal for controlling positioning of a cursor on a display screen; and
a link inserted through said ball receptacle and coupled between said positioning member and said transmission mechanism for enabling said housing to be moved relative to said positioning member and adapted to force said transmission mechanism to drive said encoder means of a circuit board installed in said housing, said link having a first ball fixedly located on a bottom end thereof and fastened pivotally with said positioning member, a second ball fixedly located on a middle part thereof and received in the ball hole of said ball receptacle, and a top free end coupled to said transmission mechanism.

12. The digital input device as claimed in claim 11, wherein said transmission mechanism comprises a first pivot bearing means and a second pivot bearing means arranged at right angles, a first arched transmission device and a second arched transmission device respectively fastened pivotally with said first pivot bearing means and said second pivot bearing means and extended across each other.

13. The digital input device as claimed in claim 12, wherein said first arched transmission device and said second arched transmission device each comprise a longitudinally arched sliding slot where through the top free end of said link passes.

14. The digital input device as claimed in claim 12, wherein said first arched transmission device and said second arched transmission device each comprise a pivot means respectively fastened pivotally with said first pivot bearing means and said second pivot bearing means.

15. The digital input device as claimed in claim 12, wherein said first arched transmission device and said second arched transmission device each comprise a transmission wheel disposed at one end for output of transmission force.

16. The digital input device as claimed in claim 12, wherein said first pivot bearing means and said second pivot bearing means are located on said ball receptacle.

17. The digital input device as claimed in claim 12, wherein said first pivot bearing means and said second pivot bearing means are fixedly mounted inside said housing.
